(19) United States
(12) Patent Application Publication
(10) Pub. No.: US 2025/0256902 A1
(43) Pub. Date: Aug. 14, 2025

(54) POLYBUTENE-1 IN EXTRUSION COATING FOR CONTROLLED PEEL FORCES

(71) Applicant: Equistar Chemicals, LP, Houston, TX (US)

(72) Inventors: John S. Laszewski, Cincinnati, OH (US); Nicole A. Gerwe, Cincinnati, OH (US); Robert Scott Weber, Mason, OH (US)

(73) Assignee: Equistar Chemicals, LP, Houston, TX (US)

(21) Appl. No.: 19/048,227

(22) Filed: Feb. 7, 2025

Related U.S. Application Data
(60) Provisional application No. 63/553,227, filed on Feb. 14, 2024.

(51) Int. Cl. B65D 77/20; B32B 7/06; B32B 27/32; C09J 7/35

(52) U.S. Cl. CPC B65D 77/2096; B32B 7/06; B32B 27/32; C09J 7/35; B32B 2307/30; B32B 2307/72; B32B 2307/7376; B32B 2439/00; C09J 2203/37; C09J 2301/304

(57) ABSTRACT

A peelable sealing composition for a sealing layer on extrusion coated packaging is described. The peelable sealing composition combines 10 to about 40 wt. % of polybutene-1 with a at least one polyolefin, and can be extrusion coated as a sealing layer directly onto a substrate, or coextruded with intermediate polymer layers onto a substrate. The resulting sealing layer can be heat sealed to allow for a controlled open package.

### PRIOR RELATED APPLICATION

This application claims the benefit of priority to U.S. Provisional Application No. 63/553,227, filed on Feb. 14, 2024, which is incorporated here by reference in its entirety.

### FIELD OF THE INVENTION

The present disclosure relates generally to flexible packaging, and in particular, to flexible packaging having a peelable sealing joint.

### BACKGROUND OF THE INVENTION

Flexible packaging is a type of packaging that can be customized to fit the shape and size of its contents. It is produced from paper, plastic, film, aluminum foil, or any combination of those materials, and includes bags, pouches, liners, wraps, rollstock, and other flexible products. Flexible packaging has many advantages including lightweight construction, cost-efficiency, and customizability. It has also been used to extend the shelf life of perishable goods while protecting them from damage. As such, flexible packaging has been found in a variety of industries including food and beverage, pharmaceuticals, personal care, pet products, and industrial supplies.

Flexible films, in particular, have been used as lightweight packaging with a substantially hermetic seal for shipping and storage of a variety of food products, including, for example, crackers, chewing gum, chocolate, cookies, cheese, sandwiches, biscuits, candy, meat products, and dried fruits and vegetables.

In the last decades, various peel/seal combinations for a peelable sealing joint on packaging films have been developed. For high quality peel film applications, the quality criteria are extremely selective, and the opening force should be considerably lower than the internal cohesion force of the peeling film and the substrate supporting this film to avoid delamination. Additionally, without careful design, the peel force required to open the flexible package can be very high, creating difficulty for the consumer. Or, the peel's initiation force can exceed the peel's propagation force, creating an uncontrolled opening and potential spillage of contents such as food.

Finally, the peel strength for a peelable sealing layer has to be operable over a broad heat seal temperature window, especially for fully automatic packaging lines where the sealing speed is of a major importance. Thus, it is desirable to develop a peelable sealing composition that can be used with extrusion coating applications.

### SUMMARY OF THE INVENTION

The present disclosure is directed to a composition that can be used as a peelable seal layer in extrusion coating application. In particular, the peelable sealing composition comprises polybutene-1 (PB-1) to provide the controlled peeling mechanism in the sealable layer. Polybutene-1 has been used in blown and cast film structures in small percentages in sealing layers to lower the peel force in a controllable manner. However, it has not been used in extrusion coating application as PB-1 was not expected to maintain the scalability in the relatively high extrusion temperatures and shear rates of extrusion coating processes. Thus, separate techniques have been used to provide the sealing mechanism in extrusion coatings.

In more detail, the disclosure provides a peelable sealing composition that can be used as a peelable sealing layer and a method for extrusion coating a substrate for flexible packaging. The peelable sealing layer composition has about 10 to about 40 wt. % of polybutene-1 and about 60 to about 90 wt. % of at least one polyolefin. The sealing composition can be extruded as a seal layer, coextruded with a core polymer layer, wherein the core polymer layer coats a substrate such as kraft paper or foil. Alternatively, the peelable sealing composition can be extruded directly onto the substrate, also called a “monolayer”. In another embodiment, the intermediate or “core” layer can consist of other materials separating the substrate and the peelable sealing layer. In some embodiments, the core layer can have multiple discreet layers of various components. Methods of extrusion coating with the composition are also described.

The PB-1 in the presently disclosed composition has an appropriate molecular weight for use in existing film conversion processes, and a melt index (190° C., 2.16 kg, g/10 min) between about 0.8 to about 15, per ISO 1133.

The peelable sealing layer comprising the sealing composition can be heat sealed to itself at temperatures in the range of about 80 to about 200° F. or in the range of about 105-160° F. In other embodiments, the peelable sealing layer comprising the sealing composition can be heat scaled directly to a substrate that is different and separate from the substrate that was part of the extrusion coating step. For example, the peelable sealing layer can be extrusion coated onto a flexible aluminum foil “lid” substrate (first substrate) but heat sealed to the rim of a plastic cup (second substrate) housing food.

The amount of seal strength using the presently described peelable scaling composition is in the range of at least 0.2 lbf/in and up to 10 lbf/in (measured at a rate of 8 in/min, according to ASTM F88/F88M-15 using Technique B for tail support). The amount of PB-1 used in the peelable sealing composition will be determined by the desired amount of seal strength used for a controlled opening force. For example, not all applications will require an “easily” openable seal. Those applications may have a high seal strength that is closer to 10 lbf/in, whereas seals used in package for potato chips may be lower. In some embodiments, the amount of PB-1 in the peelable sealing composition is selected to achieve a peel initiation force that is equal to or almost equal to the propagation force, thus allowing for a controlled opening mechanism.

The peelable sealing composition has at least one polyolefin. The polyolefin can be a homopolymer and/or copolymer. In some embodiments, the polyolefin is ethylene vinyl acetate (EVA), low density polyethylene (LDPE), linear low density polyethylene (LLDPE), metallocene catalyzed linear low density polyethylene (mLLDPE), high density polyethylene (HDPE), medium density polyethylene (MDPE), polypropylene (PP), or combinations thereof.

A peelable sealing composition can be extruded using any known method of extrusion coating. The peelable sealing composition can be extruded through an extruder having a die temperature of about 300-650° F. and a line speed of about greater than 0 feet/min to about 3000 feet/min. In some embodiments such as snack food packaging, the extrusion of the peelable scaling composition may run at 2,500 feet/min.

In some embodiments, the flexible packaging can include at least a sealing layer comprising the peelable sealing composition and any known substrate used in flexible packaging, including without limitation, paper-based materials, metallic foils, polymer films and/or combinations thereof.

The peelable sealing composition can also be coextruded (CoEx) with one or more additional layers. For example, the peelable sealing composition can be simultaneous extruded with one or more different polyolefin-based resins into a sandwich-like structure with clearly distinguishable individual layers.

The present compositions and methods include any of the following embodiments in any combination(s) of one or more thereof:

A peelable sealing composition comprising about 10 to about 40 wt. % of polybutene-1 and about 60 to about 90 wt. % of a polyolefin.

A sealing composition comprising about 20, 30 or 40 wt. % of polybutene-1 and the balance is a polyolefin.

A sealing composition comprising about 10 to about 40 wt. % of polybutene-1 and about 60 to about 90 wt. % of at least one ethylene homopolymer and/or copolymer.

A sealing composition comprising about 10 to about 40 wt. % of polybutene-1 and about 60 to about 90 wt. % of at least one propylene homopolymer and/or copolymer.

A sealing composition comprising about 10 to about 40 wt. % of polybutene-1 and about 60 to about 90 wt. % of an EVA.

A sealing composition comprising about 10 to about 40 wt. % of polybutene-1 and about 60 to about 90 wt. % of two or more ethylene homopolymers, ethylene copolymers, propylene homopolymers, propylene copolymers, or combinations thereof.

A sealable layer having a seal strength of at about 0.2 lbf/in to about 10 lbf/in, measured at a rate of 8 in/min, according to ASTM F88/F88M-15 using Technique B for tail support).

A method of extrusion coating a sealing layer on a flexible package comprising extruding onto the flexible package, any of the above sealing compositions through an extruder having a die temperature of about 300-650° F. and a line speed of about greater than 0 feet/min to about 3000 feet/min. The flexible package may comprise a monolayer sealing layer extruded onto a substrate or a coextruded multilayer structure of a core layer between the substrate and sealing layer.

A method of extrusion coating a sealing layer on a flexible package comprising co-extruding onto the flexible package, any of the above sealing compositions and at least two other materials through an extruder having a die temperature of about 300-650° F. and a line speed of about greater than 0 feet/min to about 3000 feet/min.

A multilayered packaging having (1) a sealing layer comprising 10 to about 40 wt. % of polybutene-1 and about 60 to about 90 wt. % of one or more polyolefins selected from the group consisting of ethylene homopolymers, propylene homopolymers, ethylene copolymers, and propylene copolymers, (2) a first substrate; and (3) an optional intermediate layer between said surface layer and said substrate, wherein said intermediate layer has one or more discrete layers. The sealing layer can be sealed to itself or to the substrate or a second substrate at a sealing area.

A controlled opening container having a (1) lid that has a sealing layer having 10 to about 40 wt. % of polybutene-1 and about 60 to about 90 wt. % of one or more polyolefins selected from the group consisting of ethylene homopolymers, propylene homopolymers, ethylene copolymers, and propylene copolymers, a first substrate; and an optional intermediate layer between said sealing layer and said first substrate, wherein said intermediate layer has one or more discrete layers therein have one or more polyolefins; and (2) a container having bottom wall have a second substrate; and a side wall upstanding from the bottom wall, the side wall having said second substrate and having on its upper surface a circular sealing area extending circularly thereon, the sealing area being adapted to seal the easily openable container with said lid by heat sealing the sealing layer of said lid circularly to the controlled openable container at the sealing area. Any shape can be used with the sealing area. The peel strength between the sealing layer and the optional intermediate layer and the first substrate is larger than the peel strength between the sealing layer and the side wall.

Any of the above compositions, methods, packaging or containers, wherein the substrate is paper, metallic foils, polymer films, or combinations thereof.

Any of the above packaging or containers, wherein the peel initiation force of the seal area is equal to the propagation force.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

These and other features, aspects, and advantages of the present disclosure will become better understood with reference to the following description and appended claims, and accompanying drawing figure where:

FIG. 1 is an illustrative depiction of common seal peel terminology.

FIG. 2A depicts the peel force across seal length for a peelable sealing composition (20 wt. % of Copolymer 1 and 80 wt. % LDPE) sealed at 120° C.

FIG. 2B depicts the peel force across seal length for a 100% LDPE control composition sealed at 95° C.

FIG. 3 is the average seal strength across various sealing temperatures for various loadings of Copolymer 1 in LDPE.

FIG. 4 is the seal strength across a range of sealing temperatures for peelable sealing compositions with 20 wt. % of selected polybutene-1 grades in LDPE.

FIG. 5 is the average seal strength across a sealing temperature window for various aging time periods from extrusion to sealing, for a peelable sealing composition having 20 wt. % Copolymer 1 in LDPE.

FIG. 6A is a schematic of a sealing layer comprising the peelable sealing composition directly on a substrate.

FIG. 6B is a schematic of a multilayer film using the presently described peelable composition.

FIG. 6C is a schematic of a controlled open container using the presently described peelable composition.

FIG. 7A is a SEM Cross-Section of Sealed Structure Containing 20 wt. % Homopolymer 2 at 2000× Magnification.

FIG. 7B is a SEM Cross-Section of Sealed Structure Containing 20 wt. % Homopolymer 2 at 5000× Magnification.

It should be understood that the various embodiments are not limited to the arrangements and instrumentality shown in the drawing figure.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

The term “polybutene-1” refers to a polyolefin produced by the polymerization of butene-1, which has a double bond between the first and second carbon atoms. The polymerization of polybutene-1 is a carefully controlled reaction to ensure the resulting polymer has an isotactic structure. In some embodiments, polybutene-1 may also include ethylene and/or propylene comonomers.

The terms “ethylene polymer” or “polyethylene” are used interchangeable and are intended to embrace, as alternatives, both a single ethylene polymer and an ethylene polymer composition, and encompasses both homopolymers and copolymers.

The comonomer or comonomers present in the ethylene copolymers are generally selected from olefins having formula CH₂═CHR wherein R is an alkyl radical, linear or branched, having from 1 to 10 carbon atoms. Specific examples are propylene, butene-1, pentene-1, 4-methylpentene-1, hexene-1, octene-1 and decene-1. In some embodiments, the comonomer is a vinyl acetate.

As used herein, “HDPE” means high density polyethylene—i.e., ethylene homopolymers and ethylene copolymers produced in a suspension, solution, slurry, or gas phase polymerization process and having a density in the range of 0.940 g/cm³ to 0.970 g/cm³.

As used herein, “LDPE” means low density polyethylene—i.e., ethylene homopolymers and ethylene copolymers produced in a high pressure free radical polymerization process and having a density in the range of 0.917 g/cm³ to 0.930 g/cm³.

As used herein, “LLDPE” means linear low density polyethylene—i.e., ethylene homopolymers and ethylene copolymers produced in a gas phase polymerization process polymerization process and having a density in the range of 0.915 g/cm³ to 0.940 g/cm³. LLDPE can be prepared using a variety of catalysts, include metallocene catalysts (mLLDPE).

As used herein, “EVA” means a copolymer of ethylene and vinyl acetate, wherein the vinyl acetate is present in an amount that varies between 10 to about 40 wt. %.

The terms “propylene polymer” or “polypropylene” are used interchangeable and are intended to embrace, as alternatives, both a single propylene polymer and a propylene polymer composition, and encompasses both homopolymers and copolymers.

The terms “peel force”, “peel strength”, and “seal strength” are used interchangeably and refer to the measure of the average force to peel or separate two bonded materials apart. The seal strength is calculated during a peel test at a constant speed rate as the average force to pull the layers apart over the length of the seal.

As used herein, “wt. %” means weight percent.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the disclosure.

### Peelable Sealing Composition

The presently disclosed peelable sealing composition combines about 10 to about 40 wt. % of a PB-1 and about 60 to about 90 wt. % of at least one polyolefin such as ethylene or propylene homopolymer and/or copolymers.

PB-1 is shear-thinning, meaning its shear viscosity decreases with increasing shear rate. PB-1 shear thins more dramatically than polyethylene, and we have found that this allows PB-1 to be introduced into polyethylene or polypropylene without significant changes to extrusion coating conditions. Further, we have found that PB-1 allows a user to control the seal strength, allowing for control on the amount of forces to peel a sealing layer described herein in extrusion coating applications.

In more detail as to one embodiment, when PB-1 is blended into, for example, polyethylene, the PB-1 forms discreet domains within a continuous polyethylene phase. When present in the sealing layer of a heat-sealed package, these discreet domains decrease the peel force of the seal. We believe, without being tied to any one theory, that the continuous polyethylene phase in the seal layer forms a strong bond on a polyethylene core layer that is coated on the substrate. The dispersed polybutene-1 domains form a weak bond to the polyethylene core layer, which results in an overall lower peel force compared to a complete polyethylene structure. The polyethylene-polybutene-1 seal structure will still create a high-integrity seal, capable of holding internal pressure or vacuum. Increasing the concentration of polybutene-1 in the seal layer will further lower peel force, allowing for structures to be engineered for meeting a target average peel force.

The PB-1 can be a homopolymer, a copolymer, or a combination thereof. In some embodiments, the PB-1 has a density that ranges from about 0.890 to about 0.930 g/cm³. In some embodiments, the PB-1 has a melt index (190° C., 2.16 kg, g/10 min) that ranges from about 0.2 to about 15. Any molecular weight of PB-1 that is used for existing film conversion processes can be used in the presently described compositions.

The polyolefin in the peelable sealing composition can be a polyethylene or a polypropylene. In some embodiments, the sealing composition has about 60 to about 90 wt. % of EVA, LDPE, mLLDPE, LLDPE, PP, or combinations thereof. When selecting a polyolefin for the sealing composition, the PB-1 and polyolefin melt indices should be close to each other to ensure an even distribution of PB-1 throughout the seal layer. Inclusion of a PB-1 grade with too low of melt viscosity compared to the polyolefin may result in poor dispersion of PB-1, and ultimately higher peel forces and inconsistent performance. In some embodiments, the polyolefin in the sealing composition has a melt index (190° C., 2.16 kg, g/10 min) that ranges from about 0.2 to about 15.

In some embodiments, the sealing composition is a combination of PB-1, PP, and a PE, wherein the PB-1 helps with sealing temperature reduction and the PE is used to provide an incompatible interaction with the PB-1 to aid in a controlled peel force.

In some embodiments, the peelable sealing composition is heat sealed to itself. In other embodiments, the sealing composition can be heat sealed to an all-polyethylene layer or an all-polypropylene layer, or a blend of at least one polyethylene and at least one polypropylene layer.

In some embodiments, the sealing composition can also include one or more additional additives. Suitable types of additives for preparing sealing compositions are, for example, antioxidants, melt stabilizers, light stabilizers, acid scavengers, lubricants, processing aids, antiblocking agents, slip agents, antistatic agents, antifogging agents, pigments or dyes, nucleating agents, flame retardants or fillers. It is common that several additives are added. The multiple additives can be different types of additives. It is however also possible that several representatives of one type of additives are added to the polyethylene composition. Additives of all these types are generally commercially available and are described, for example, in Hans Zweifel, Plastics Additives Handbook, 5th Edition, Munich, 2001.

### Extrusion Coating

The sealing composition can be layered, or coextruded with a core layer that is situated on a flexible substrate using an extruder. The core layer can be a polyolefin layer, or it can be a multilayered structure with some or all layers being comprised of at least one polyolefin. In other embodiments, the sealing composition is layered directly onto a flexible substrate, with no other core layer coextruded alongside the sealing composition.

Any known extruder for extrusion coating can be used, including in in particular single screw extruders.

The substrate can be any used in flexible packaging. In some embodiments, the substrate is paper-based such as kraft paper or paperboard. In other embodiments, the substrate is a fiber, including without limitation, wovens, nonwovens, carpet, and spun fibers. In other embodiments, the substrate is a metallic foil or polymer film. In yet other embodiments, the substrate is polyethylene terephthalate, polyamides, polyaramids, biaxially oriented PP (BOPP) and other types of polymers.

In some applications, layered on top of the substrate is an intermediate layer. The intermediate layer can be a layer of a single material or a structure with multiple, discrete layers of the same or different materials. In some embodiments, the intermediate layer is a polymer such as polyethylene, polypropylene, polyester, polyvinylchloride, polyamide, and/or polyacrylonitrile.

In some embodiments, the peelable sealing composition is about 15% or less than the total thickness of the layers on the substrate. In other embodiments, the peelable sealing layer is at least 5 microns, at least 10 microns at least 12 microns, or at least 15 microns thick.

In some embodiments of applying the peelable sealing composition, the extrusion temperature at the die is between about 300 and about 650° F., or 600 and about 650° F. The line speed is between greater than 0 and 3,000 feet/min, or between about 300 to 3,000 feet/min, or between about 1000 to 2000 feet/min, or between about 400 and 600 feet/min. In other embodiments, the extrusion temperature at the die is about 615° F., and the line speed is about 500 feet/min.

Once applied to the flexible packaging, the sealing composition can be heat sealed to itself immediately or at some time later after the extrusion process. In some embodiments, the sealing composition is heat sealed to itself between 0 and 7 days after extrusion. In other embodiments, the sealing composition is heat sealed to a second, separate substrate or an unlayered portion of the first substrate.

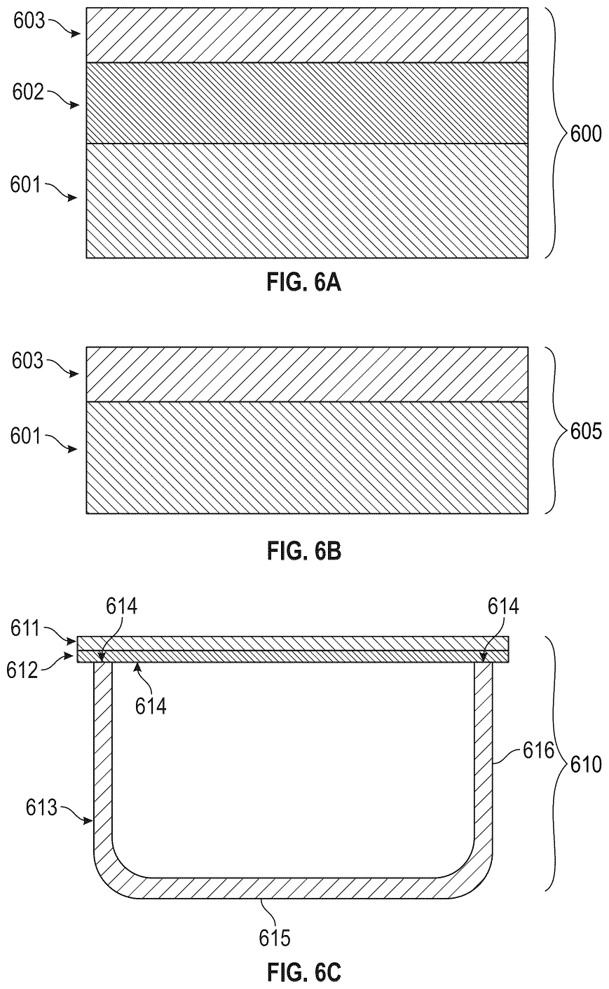

The peelable sealing composition can be used in a variety of extrusion coating applications. One such application is in a multilayered film 600, as show in FIG. 6A. Here the multilayer film has a substrate 601, an intermediate layer 602, and the presently described layer of the peelable sealing composition 603. The intermediate layer 602 can be a single layer (as shown) or a multilayered structure with discrete layers therein. FIG. 6B displays a monolayer flexible packaging 605 wherein the layer of the peelable sealing composition 603 is directly on the substrate 601. Alternatively, the peelable sealing composition can be used in controlled opening containers, such as that shown in FIG. 6C. Here, the controlled opening container 610 has a substrate 611, and the presently described peelable sealing composition 612, same as the packaging in FIG. 6B, forming a lid. The controlled open container 610 also has a second substrate 613 to form the container that may hold e.g. food. Reference number 615 represents the bottom of the container formed by the second substrate and reference number 616 represents the side of the container formed by the second substrate. Reference number 614 is the sealing area wherein the sealing layer 612 has been heat sealed to the second substrate 613 along the top edge of the side of the container. In some embodiments, the peel strength between the lid and the container 613, after being heat sealed, is between 0.2 and 10 lbf/in. The lid in FIG. 6C could also be that of FIG. 6A.

### EXAMPLES

The practice and advantages of the various embodiments, compositions and methods as provided herein are disclosed below in the following examples. These Examples are illustrative only, and are not intended to limit the scope of the appended claims in any manner whatsoever.

A variety of commercially available PB-1 grades were selected for extrusion coating alongside a low density polyethylene. Table 1 describes the materials used in this example. All resins were obtained from LyondellBasell (Houston, TX).

TABLE 1
Materials used for the extrusion coated samples

| | | | Melt Index | |
|---|---|---|---|---|
| | | | (190° C., | |
| Material | Commercial | Polymer | 2.16 kg, | Density |
| name | Grade Name | Type | g/10 min.) | (g/cm³) |
| Homopol- | Toppyl PB0110M | Polybutene-1 | 0.4 | 0.915 |
| ymer 1 | | | | |
| Homopol- | Koattro PB0300M | Polybutene-1 | 4.0 | 0.915 |
| ymer 2 | | | | |
| Copolymer 1 | Toppyl PB8640M | Polybutene-1 | 0.9 | 0.906 |
| Copolymer 2 | Toppyl PB8340M | Polybutene-1 | 4.0 | 0.906 |
| LDPE 1 | Petrothene | Low Density | 10.0 | 0.918 |
| | NA214000 | Polyethylene | | |

The PB-1 grades were selected such that both homopolymer and copolymers, and high and low melt index PB-1, were tested.

### Methods

The following methods were used to prepare the extrusion coated samples.

A multi-layer, 30 inch-wide extrusion coating line was used to create the samples. All specimens evaluated in this study were created by coating 40 pound kraft paper with a two-layer polymer structure. The structure consisted of a seal layer comprising the presently described peelable sealing composition and a core layer sandwiched between the kraft paper substrate and the seal layer. The core layer was 100% low density polyethylene (hereinafter LDPE 1) that was extruded 10 microns thick. The seal layer consisted of the various PB-1 grades shown above in Table 1, at various loadings. The PB-1 grades were dry blended with LDPE 1 and extruded at 15 micron thickness on top of the core LDPE 1 layer. During the trials, the extrusion temperature at the die was 615° F., and the line speed was 500 feet/min. The extrusion coating line was allowed to run for 10 minutes at these conditions before samples were taken, to ensure steady state shear conditions were reached.

Extruded samples were cut to 4.5″×1″ size and sealed either within 24 hours or after a specified aging period. For this study, all samples that were sealed within 24 hours of extrusion were considered equivalent with respect to time between extrusion and sealing. Heat scaling was done in either 5 or 10° C. increments by sealing on a benchtop heat sealer for 0.5 seconds at 40 psi, sealing a 1″×1.5″ section. Samples were sealed to themselves, creating symmetrical structure. Samples were aged at room temperature for 7 days after sealing before peeling.

An Instron Universal Testing Machine-Model 5542 was used to measure peel strength. A loose end was secured to each arm of the machine and pulled apart at a crosshead speed of 8.0 in/min. The machine recorded the peel strength along the length of the seal. Samples were peeled in order from lowest seal temperature to highest, until consecutive samples exhibited delamination failure. Seal peeling was done according to ASTM F88/F88M-15 using Technique B for tail support (version 2015).

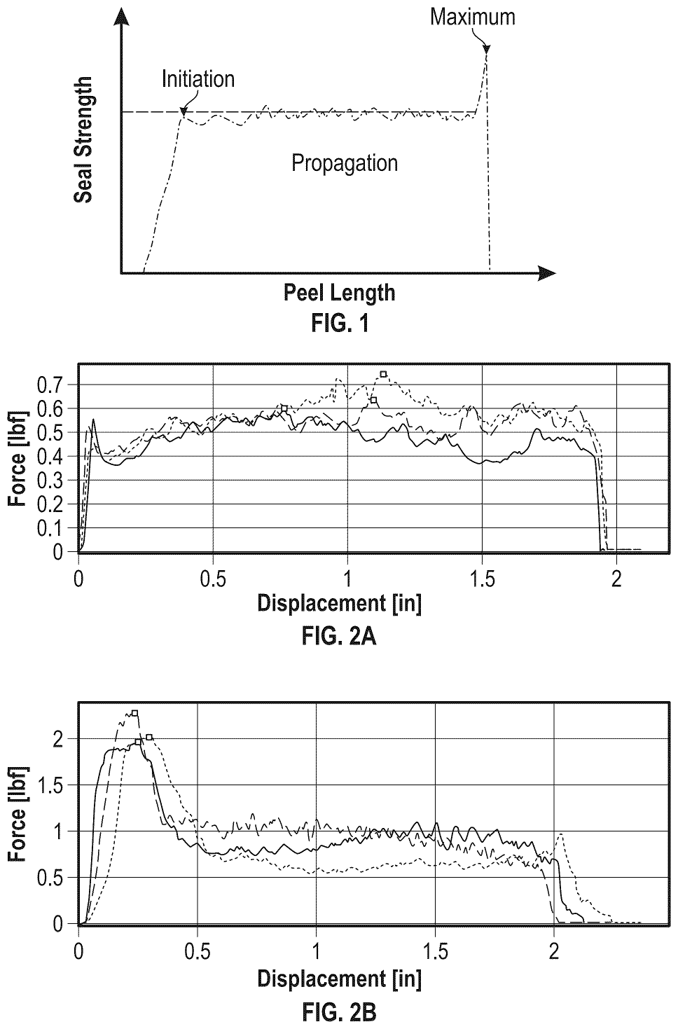

Average peel force is defined as the force required to peel apart the seal, averaged across the length of the seal. A sealed sample will require some minimum force before the separation of the seal begins, which is referred to as the peel initiation force. For a controlled peel, the peel initiation force must be similar to the force required to propagate the peel, see FIG. 1. In this work, samples exhibited two types of peeling mechanisms: cohesive peel and delamination. Cohesive peel occurs when the peel happens between seal layers, leaving the structures intact as they were before peeling. Delamination occurs when the seal strength is so great, that the polymer layer pulls away from the substrate, which in these experiments is kraft paper. When using kraft paper or other fibrous substrates, this phenomenon is also commonly referred to as “fiber tear.”

Delamination failure was determined by technician's observation of polymer peeling away from the kraft paper backing or kraft paper internally tearing, rather than the peel occurring between seal layers.

### Example 1

In one set of experiments, the seal layer was made by dry blending Copolymer 1 with LDPE 1 at 10 wt. %, 20 wt. %, and 30 wt. % to produce a seal layer that was compared against 100 wt. % LDPE 1 as a control sample. Extrusion coated specimens with this seal layer were created, sealed, and peeled. The samples were sealed within 24 hours of extrusion. The peel force along the length of the peel for 20% Copolymer 1, sealed at 120° C., is shown in FIG. 2A. The peel force along the length of the seal for a 0% PB-1 control is shown in FIG. 2B. The curve shown in FIG. 2B was sealed at 95° C. and delaminated when peeled. Since the sample sealed at 95° C. delaminated when peeled, it was not sealed at higher temperatures. Three replicates are shown in both FIGS. 2A and 2B.

In FIG. 2B, the peel force of the control composition peaks at about 0.2 inches of displacement, then drastically falls, demonstrating delamination and an uncontrolled peeling mechanism. The presence of 20 wt. % Copolymer 1, however, reduces this initiation energy to be roughly equal to the average peel force, creating a smooth peel across the length of the seal. The presence of the Copolymer 1 also lowered the average peel force, from 0.94 lbf/in in the control (FIG. 2B) to 0.53 lbf/in in the 20 wt. % Copolymer 1 sample (FIG. 2A.).

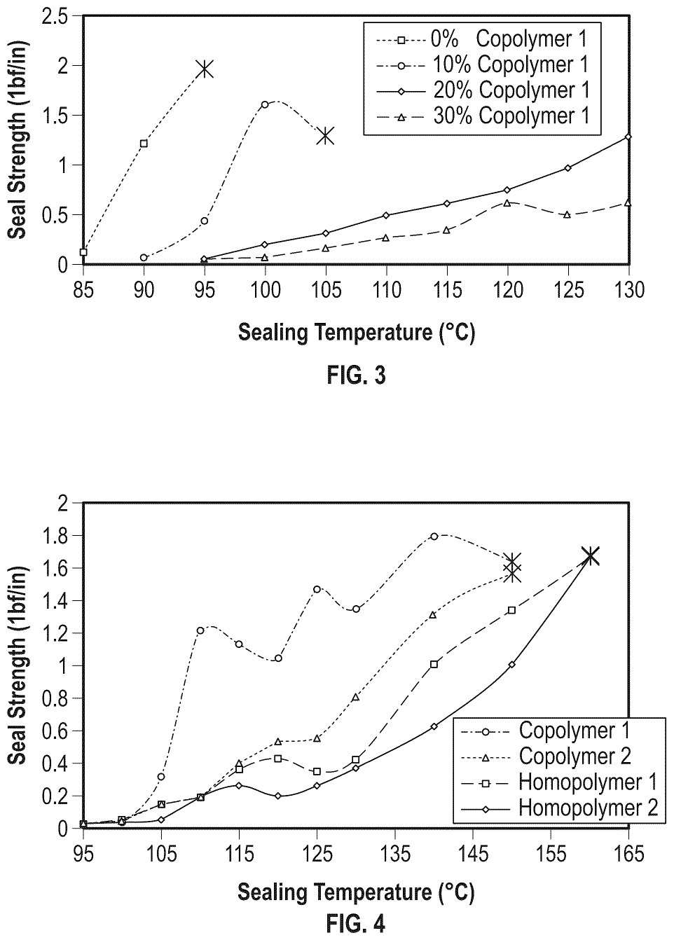

FIG. 3 displays the average peel force of three replicates of each Copolymer 1 sample at a given seal temperature alongside the 0 wt. % PB-1 control. Delamination failure is indicated with an asterisk data marker at the end of the curve in this figure.

The 20 wt. % and 30 wt. % Copolymer 1 samples did not exhibit delamination failure at the sealing temperatures tested. However, as little as 10 wt. % Copolymer 1 present in the seal layer reduces the average peel force significantly. It also increased the delamination temperature by 10° C., from 95° C. to 105° C. Increasing polybutene-1 loading to 20 wt. % further lowered the average peel force, and no delamination failure was seen at least up to a seal temperature of 130° C. Both the 20 wt. % and 30 wt. % Copolymer 1 loaded samples demonstrated a broader scaling window compared to the control, as defined by the temperature range within which the sample can be sealed and still be cohesively peeled. The sealing window was increased from less than 10 degrees (85° C. to <95° C.) in the control to over 35 degrees (95° C. to >130° C.) in the 20 wt. % and 30 wt. % samples. This broadened sealing window is advantageous for packaging manufacturers, as it allows for flexibility in the sealing conditions while maintaining consistent peel force.

To understand the consistency of the measured peel strength and variability in the data, thirty replicates of the 20 wt. % Copolymer 1 structure were sealed at 115° C., 120° C., 125° C., and 130° C. A flat sealing window was observed between 115° C. (average of about 3.9 lbf/in) and 120° C. (average of about 3.85 lbf/in). The samples sealed at 125° C. had the greatest variability, but this is attributed to imperfect dry mixing of the components, variations in extrusion conditions, thickness in sealing layer, and/or time between extrusion and sealing.

### Example 2

In view of the results of Example 1, samples containing 20% of each of the four selected polybutene-1 grades in Table I were created to explore the effect the polybutene-1 grade selection has on peel force. As before, each sample was sealed within 24 hours of extrusion and sealed to themselves. The peel force of each structure across the sealing temperature window is shown in FIG. 4.

All four polybutene-1 grades were effective at lowering average peel force below the all-polyethylene control. Homopolymer 2 and Copolymer 2 outperformed Homopolymer 1 and Copolymer 1 in effectiveness in lowering average peel force. This suggests that melt index is more important in lowering the peel force than the presence of comonomer. Homopolymer 2 slightly outperforms Copolymer 2. Without being bound by any theories, this could be related to the higher crystallinity and the relatively high temperatures of extrusion coating. However, more work is needed in this area. Copolymer 1 outperforming Homopolymer 1 may be due to the higher melt index of Copolymer 1.

### Example 3

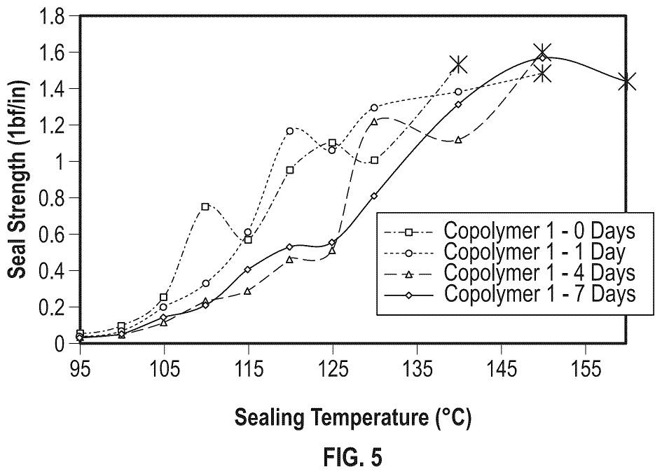

In Example 3, the effect of the time period between extrusion and sealing was evaluated using a composition with 20 wt. % of Copolymer 1. The samples were aged 0, 1, 4, and 7 days between extrusion and sealing, and each sample was aged an additional seven days after scaling and before peeling. The results are shown in FIG. 5. The peel strength decreased with increasing aging between extrusion and scaling.

The effect of time from extrusion to sealing was also explored for Copolymer 2, Homopolymer 1 and Homopolymer 2, all at 20 wt. % of the sealing layer. These samples were sealed after 0 days from extrusion and after 7 days from extrusion. The amount of time between extrusion and sealing was consistent with the results seen with Copolymer 1. The increase in time reduced the peel force.

Without being bound to any theory, it is suspected that this decrease in peel force is due to the recrystallization phenomenon of PB-1. PB-1 has two crystalline forms, Form I and Form II. Form II is a metastable form with tetragonal structure and is obtained directly from molten state of PB-1. In contrast, Form I is a stable form with a hexagonal structure. As more time passes from extrusion to sealing, more PB-1 crystalline Form II is thought to convert to Form I, where it has a greater enthalpy of fusion and higher overall degree of crystallinity. This may result in a seal which is capable of absorbing more heat before softening, evident in the seal curves shifting to the right by 10 to 15° C., both in average peel force and in delamination temperature. To achieve consistent peel forces across packages, one should take care to either wait to seal the package seven days after extrusion, once the PB-1 has fully recrystallized, or to hold the extrusion to sealing time relatively constant.

### Example 4

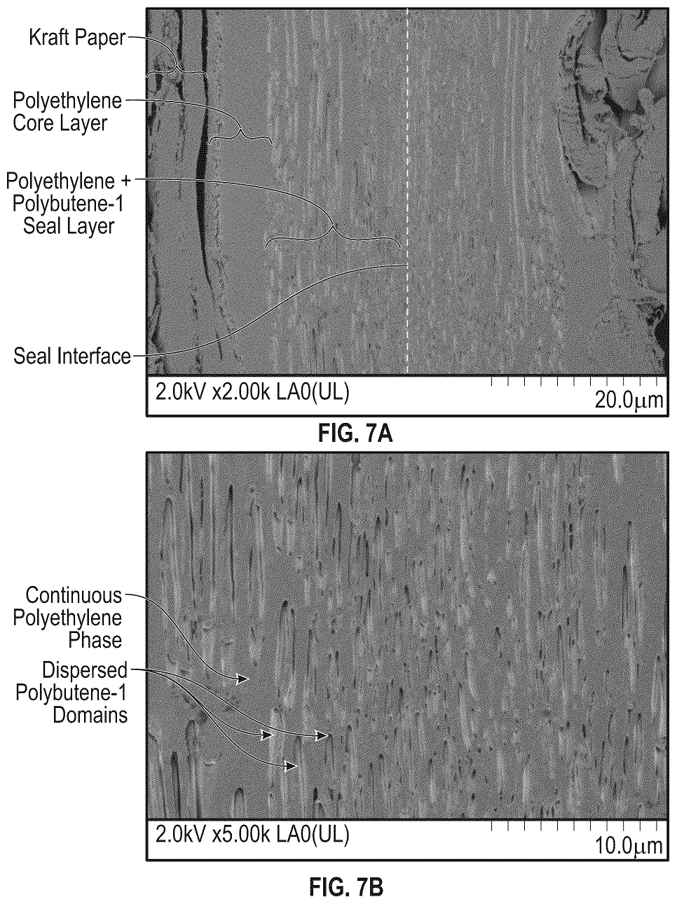

A scanning electron microscopy (SEM) was used to create a visual depiction of the 20% Homopolymer 2 samples to view the seal interface. A higher level of dispersion of Homopolymer 2 within the polyethylene was seen as smaller Homopolymer 2 domains with the continuous polyethylene matrix, near the interface, as shown in FIG. 7A and FIG. 7B.

Increased PB-1 dispersion can be achieved by increasing the shear experienced by the sealing composition during extrusion. An increased level of dispersion will result in comparatively lower peel forces. Additional testing is needed to explore a variety of processing conditions to achieve a suitable peel strength for a given flexible packaging application.

In conclusion, PB-1 could be used in a peelable composition in extrusion coating applications to control both the peel initiation force and the average peel force of, in this example, a polyethylene-based structure sealed to itself. However other structures are also feasible. Increasing the polybutene-1 loading resulted in lower average peel forces. Thus, one with skill in the art can select loadings and processing conditions to create peelable structures that open at a given force.

What is claimed is:

1. A peelable sealing composition comprising:
a. about 10 to about 40 wt. % of Polybutene-1;
b about 60 to about 90 wt. % of at least one polyolefin.

2. The peelable seal composition of claim 1, wherein the at least one polyolefin is a polyethylene homopolymer or copolymer, or a polypropylene homopolymer or copolymer.

3. The peelable seal composition of claim 1, wherein the at least one polyolefin is a ethylene vinyl acetate (EVA), low density polyethylene (LDPE), linear low density polyethylene (LLDPE), metallocene catalyzed linear low density polyethylene (mLLDPE), high density polyethylene (HDPE), medium density polyethylene (MDPE), polypropylene (PP), or combinations thereof.

4. The peelable seal composition claim 1, wherein the melt index of the polybutene-1 is between about 0.1 to about 15 g/10 min (190° C., 2.16 kg).

5. The peelable seal composition of claim 1, wherein the melt index of the polyolefin is between about 0.1 to about 15 g/10 min (190° C., 2.16 kg).

6. The peelable seal composition of claim 1, wherein the density of the polybutene-1 is between from about 0.890 to about 0.930 g/cm³.

7. A multilayered packaging, comprising:
a. a sealing layer comprising 10 to about 40 wt. % of polybutene-1 and about 60 to about 90 wt. % of at least one polyolefin selected from the group consisting of ethylene homopolymers, propylene homopolymers, ethylene copolymers, and propylene copolymers,
b. a substrate; and,
c. an optional intermediate layer between said surface layer and said substrate, wherein said intermediate layer has one or more discrete layers.

8. The multilayered packaging of claim 7, wherein said sealing layer is at least 5 microns thick.

9. The multilayered packaging of claim 7, wherein the seal strength of a seal formed by the sealing layer is between at least 0.2 lbf/in. and up to 10 lbf/in (measured at a rate of 8 in/min).

10. The multilayered packaging of claim 7, wherein said at least one polyolefin is selected from a group consisting of polyethylene vinyl acetate (EVA), low density polyethylene (LDPE), linear low density polyethylene (LLDPE), metallocene catalyzed linear low density polyethylene (mLLDPE), high density polyethylene (HDPE), medium density polyethylene (MDPE), polypropylene (PP), or combinations thereof.

11. A controlled opening container comprising:
a. a lid having
i. a sealing layer comprising 10 to about 40 wt. % of polybutene-1 and about 60 to about 90 wt. % of a polyolefin selected from the group consisting of ethylene homopolymers, propylene homopolymers, ethylene copolymers, and propylene copolymers,
ii. a first substrate;
iii. an optional intermediate layer between said sealing layer and said first substrate, wherein said intermediate layer has one or more discrete layers therein comprising one or more polyolefins; and
b. a container comprising
i. a bottom wall comprising a second substrate;
ii. a side wall upstanding from the bottom wall, the side wall comprising said second substrate and having on its upper surface a sealing area extending thereon, the sealing area being adapted to seal the easily openable container with said lid by heat sealing the sealing layer of said lid to the controlled openable container at the sealing area,
wherein the peel strength between the sealing layer and said optional intermediate layer and said first substrate is larger than the peel strength between the sealing layer and the side wall.

12. The controlled opening container of claim 11, wherein said at least one polyolefin is selected from a group consisting of polyethylene vinyl acetate (EVA), low density polyethylene (LDPE), linear low density polyethylene (LLDPE), metallocene catalyzed linear low density polyethylene (mLLDPE), high density polyethylene (HDPE), medium density polyethylene (MDPE), polypropylene (PP), or combinations thereof.

13. The controlled opening container of claim 11, wherein the peel strength between the sealing layer and the side wall of said container is between at least 0.2 lbf/in. and up to 10 lbf/in (measured at a rate of 8 in/min).

14. The controlled opening container of claim 11, wherein the peel strength between the sealing layer and the side wall of said container is at least 10% greater than the peel strength between the sealing layer and the first substrate or optional intermediate layer, when measured at a speed of 8 in/min.

15. The controlled opening container of claim 11, wherein said first and second substrate are the same material or different materials.

16. The controlled opening container of claim 11, wherein said first substrate is a metal foil and said second substrate is a polymer.

17. The controlled opening container of claim 11, wherein both said first substrate and said second substrate is a metal foil.

18. The controlled opening container of claim 11, wherein the melt index of the polybutene-1 is between about 0.1 to about 15 g/10 min (190° C., 2.16 kg).

19. The controlled opening container of claim 11, wherein the density of the polybutene-1 is between from about 0.890 to about 0.930 g/cm³.

20. The controlled opening container of claim 11, wherein the peel initiation force of the seal area is equal to the propagation force.
